(19) United States
(12) Patent Application Publication
(10) Pub. No.: US 2026/0304587 A1
(43) Pub. Date: Oct. 1, 2026

(54) VERIFYING A REPAIR OF A PLASMA TORCH

(71) Applicant: Toyota Motor Engineering & Manufacturing North America, Inc., Plano, TX (US)

(72) Inventor: Michael Haller, Kitchener (CA)

(73) Assignees: Toyota Motor Engineering & Manufacturing North America, Inc., Plano, TX (US); Toyota Jidosha Kabushiki Kaisha, Toyota-shi Aichi-ken (JP)

(21) Appl. No.: 19/094,049

(22) Filed: Mar. 28, 2025

(51) Int. Cl. H05H 1/34

(52) U.S. Cl. CPC H05H 1/3494; H05H 2240/00

(57) ABSTRACT

A system for verifying a repair of a plasma torch can include a tool configured to grip, a rotational speed sensor, a memory, and a processor. The tool configured to grip can be configured to hold the plasma torch. The rotational speed sensor can be configured to measure a rotational speed of the plasma torch. The memory can be configured to store a measurement of the rotational speed. The processor can be configured to: (1) determine a result and (2) produce a signal indicative of the result. The result can be of a comparison between the measurement of the rotational speed and a desired range of measurements of the rotational speed.

### TECHNICAL FIELD

he disclosed technologies are directed to verifying a repair of a plasma torch.

### BACKGROUND

A manufacturing process for a product can be complex. Often, the manufacturing process can be performed as a set of sequential operations on a production line. Sometimes, the manufacturing process can include a performance of a surface modification of a material used in the product. The surface modification can be performed for a variety of reasons. For example, these reasons can include altering one or more characteristics of the surface, such as: roughness, hydrophilicity, surface charge, surface energy, biocompatibility, reactivity, adhesion properties, or the like. The performance of the surface modification can be accomplished using a variety of techniques. Such techniques can include, for example, one or more of etching, mechanical polishing, electroplating, thermal sprays, ion implantation, laser treatments, chemical vapor deposition, plasma treatment, or the like. These techniques can be associated with specific tools. In a situation in which the manufacturing process: (1) is performed as a set of sequential operations on a production line and (2) includes a performance of a surface modification of a material used in the product, a malfunction of such a specific tool can be a reason to pause one or more of the sequential operations until the specific tool is repaired.

### SUMMARY

An an embodiment, a system for verifying a repair of a plasma torch can include a tool configured to grip, a rotational speed sensor, a memory, and a processor. The tool configured to grip can be configured to hold the plasma torch. The rotational speed sensor can be configured to measure a rotational speed of the plasma torch. The memory can be configured to store a measurement of the rotational speed. The processor can be configured to: (1) determine a result and (2) produce a signal indicative of the result. The result can be of a comparison between the measurement of the rotational speed and a desired range of measurements of the rotational speed.

In another embodiment, a controller for verifying a repair of a plasma torch can include a port, a memory, and a processor. The port can be configured to receive, from a rotational speed sensor, a measurement of a rotational speed of the plasma torch. The memory can be configured to store the measurement of the rotational speed. The processor can be configured to: (1) determine a result and (2) produce a signal indicative of the result. The result can be of a comparison between the measurement of the rotational speed and a desired range of measurements of the rotational speed.

In another embodiment, a method for verifying a repair of a plasma torch can include holding, by a tool configured to grip, the plasma torch. The method can include measuring, by a rotational speed sensor, a rotational speed of the plasma torch. The method can include storing, in a memory, a measurement of the rotational speed. The method can include determining, by a processor, a result. The result can be of a comparison between the measurement of the rotational speed and a desired range of measurements of the rotational speed. The method can include producing, by the processor, a signal indicative of the result.

### BRIEF DESCRIPTION OF THE DRAWINGS

The accompanying drawings, which are incorporated in and constitute a part of the specification, illustrate various systems, methods, and other embodiments of the disclosure. It will be appreciated that the illustrated element boundaries (e.g., boxes, groups of boxes, or other shapes) in the figures represent one embodiment of the boundaries. In some embodiments, one element may be designed as multiple elements or multiple elements may be designed as one element. In some embodiments, an element shown as an internal component of another element may be implemented as an external component and vice versa. Furthermore, elements may not be drawn to scale.

FIGS. 1A and 1B include block diagrams that illustrate an example of a plasma torch.

FIG. 2 includes a block diagram that illustrates an example of an environment for verifying a repair of a plasma torch, according to the disclosed technologies.

FIG. 3 includes a block diagram that illustrates an example of a controller for verifying a repair of a plasma torch, according to the disclosed technologies.

FIGS. 4A and 4B include a flow diagram that illustrates an example of a method that is associated with verifying a repair of a plasma torch, according to the disclosed technologies.

### DETAILED DESCRIPTION

The disclosed technologies are directed to verifying a repair of a plasma torch. For example, the plasma torch can include a handheld plasma torch. For example, the plasma torch can include a plasma surface treatment tool. For example, the plasma surface treatment tool can include an atmospheric plasma surface treatment tool. For example, the plasma surface treatment tool can include a rotating plasma surface treatment tool. In a situation in which a manufacturing process: (1) is performed as a set of sequential operations on a production line and (2) includes a performance of a surface modification of a material used in the product, a malfunction of a plasma torch, used for the performance of the surface modification, can be a reason to pause one or more of the sequential operations until the plasma torch is repaired. Furthermore, if the situation includes using an industrial robot to operate the plasma torch, then an overall duration of time of a pause of the one or more sequential operations can need to account for durations of time associated with: (1) detaching a malfunctioning plasma torch from the industrial robot and (2) attaching a repaired plasma torch to the industrial robot. Moreover, because: (1) any of several operational aspects of the plasma torch can be a reason for the malfunction and (2) a correct operation of one of the several operational aspects can be affected by a correct operation of one or more other of the several operational aspects, there can be value in verifying the repair of the plasma torch prior to placing the plasma torch back in operation.

For example, a plasma torch can be held by a tool configured to grip. For example, a rotational speed of the plasma torch can be measured by a rotational speed sensor. For example, a measurement of the rotational speed can be stored in a memory. For example, a first result can be determined by a processor. For example, the first result can be of a comparison between the measurement of the rotational speed and a desired range of measurements of the rotational speed. For example, a signal indicative of the first result can be produced by the processor.

Additionally, for example, a pressure of air feedback from the plasma torch can be measured by a pressure sensor. For example, a measurement of the pressure can be stored in the memory. For example, a second result can be determined by the processor. For example, the second result can be of a comparison between the measurement of the pressure and a desired range of measurements of the pressure. For example, a signal indicative of the second result can be produced by the processor.

Additionally, for example, a voltage and an amperage applied to the plasma torch can be measured by a voltage and amperage sensor. For example, measurements of the voltage and the amperage can be stored in the memory. For example, a third result can be determined by the processor. For example, the third result can be of a comparison between the measurement of the voltage and a desired range of measurements of the voltage. For example, a signal indicative of the third result can be produced by the processor.

Additionally, for example, an intensity of a light, conveyed through an optic cable of a flame detection system of the plasma torch, can be measured by a photodetector. For example, the optic cable can be a fiber optic cable. For example, a measurement of the intensity can be stored in the memory. For example, a fourth result can be determined by the processor. For example, the fourth result can be of a comparison between the measurement of the intensity and a desired range of measurements of the intensity. For example, a signal indicative of the fourth result can be produced by the processor.

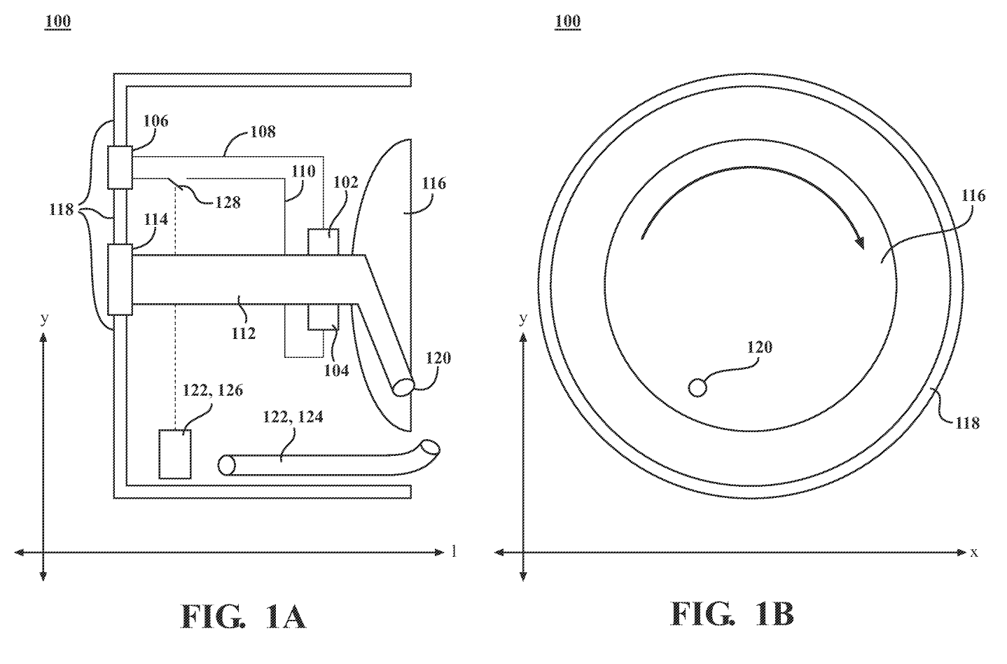

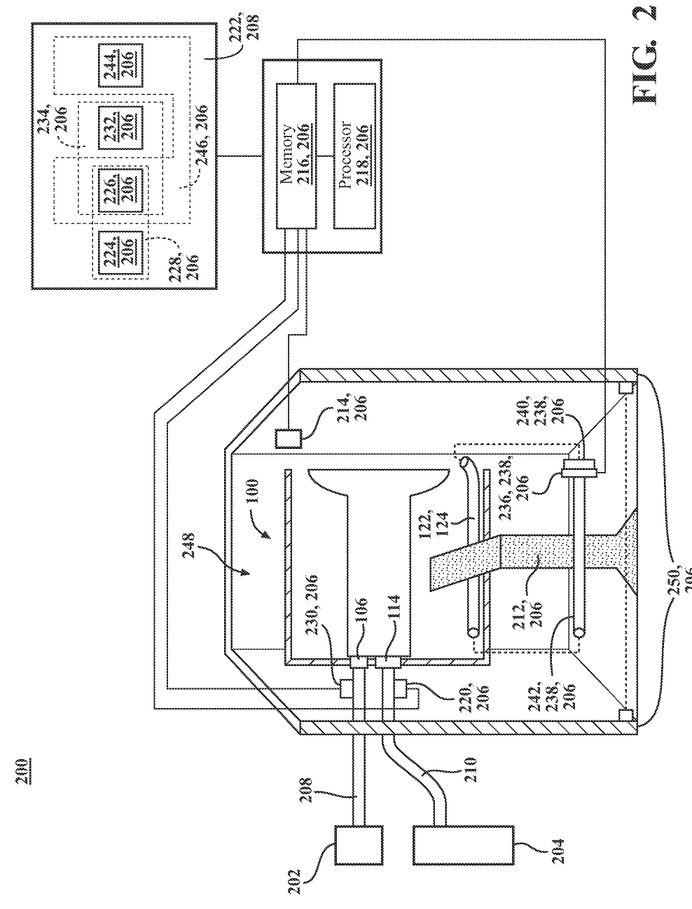

FIG. 1A includes a block diagram that illustrates an example of a plasma torch 100 from a perspective of an l-y coordinate system. FIG. 1B includes a block diagram that illustrates an example of the plasma torch 100 from a perspective of an x-y coordinate system. For example, the plasma torch 100 can include a rotating, atmospheric plasma surface treatment tool. For example, the plasma torch 100 can include a first electrode 102, a second electrode 104, an electrical connector 106, a first lead 108 (e.g., ground), a second lead 110 (e.g., high voltage) , an air tube 112, an air supply connector 114, a nozzle 116, and a housing 118. For example, the nozzle 116 can include an aperture 120.

For example, the first electrode 102 and the second electrode 104 can be configured to receive an electrical energy with an alternating current. For example: (1) the first electrode 102 can receive the electrical energy from the electrical connector 106 via the first lead 108 and (2) the second electrode 104 can receive the electrical energy from the electrical connector 106 via the second lead 110. For example, an electrical potential of the electrical energy can be between 100 and 480 volts. For example, a frequency of the alternating current can be in the radio frequency range of the electromagnetic spectrum. (e.g., kilohertz to megahertz).

For example, the air tube 112 can be configured to convey air between the first electrode 102 and the second electrode and to the aperture 120 of the nozzle 116. For example, the air tube 112 can receive the air from the air supply connector 114. For example, a pressure of the air can be between 90 and 100 pounds per square inch.

For example, application of the electrical energy at the first electrode 102 and the second electrode can ionize the air between the first electrode 102 and the second electrode so that the ionized air becomes highly conductive and attains an extremely high temperature (i.e., becomes plasma). For example, because the air is pressurized, the ionized air can be caused to flow through the aperture 120 of the nozzle 116 as a flame. For example, the flame can be visible. For example, because: (1) the aperture 120 can be located at an outer edge of the nozzle 116, (2) the plasma torch 100 can be used for a performance of a surface modification of a material used in a product, and (3) an area of a surface, of the material, to be modified can be substantially larger than a cross-sectional area of the flame emitted through the aperture 120, the nozzle 116 can be caused to rotate so that, within a specific duration of time, the area of the surface modified is larger than an area of the surface that would be modified if the nozzle 116 was not caused to rotate. Furthermore, for example, rotation of the nozzle 116 can cause the surface modification to be more evenly distributed than the surface modification would be without the rotation of the nozzle 116.

Additionally, for example, the plasma torch 100 can include a flame detection system 122. For example, if the plasma torch 100 is configured to produce a flame at a location remote from where the flame may be observed by a human operator (e.g., if an industrial robot is used to operate the plasma torch 100), then the plasma torch 100 can include the flame detection system 122. For example, the flame detection system 122 can be used as a safety feature that detects a presence of the flame. Additionally or alternatively, for example, the flame detection system 122 can be used as a quality control feature that detects an absence of the flame, which can be indicative that a surface modification, for which the plasma torch 100 is being used, is not being performed correctly. For example, the flame detection system 122 can include a glass tube (not illustrated), an optic cable 124, and a photodetector 126. For example, the optic cable 124 can be a fiber optic cable. For example, the optic cable 124 can be configured so that light from a flame emitted through the aperture 120 can enter the optic cable 124. For example, light that enters the optic cable 124 can be conveyed by the optic cable 124 and can be directed toward the photodetector 126. For example, the photodetector 126 can be configured to convert the intensity of the light into an electrical signal. Additionally, for example, the plasma torch 100 can include a switch 128 configured to control electrical conductivity through one or more of the first lead 108 or the second lead 110. For example, if the flame detection system 122 is used as a quality control feature, then the electrical signal, produced by the photodetector 126 in response to the absence of the flame, can cause the switch 128 to be in an open position to prevent electrical conductivity through one or more of the first lead 108 or the second lead 110.

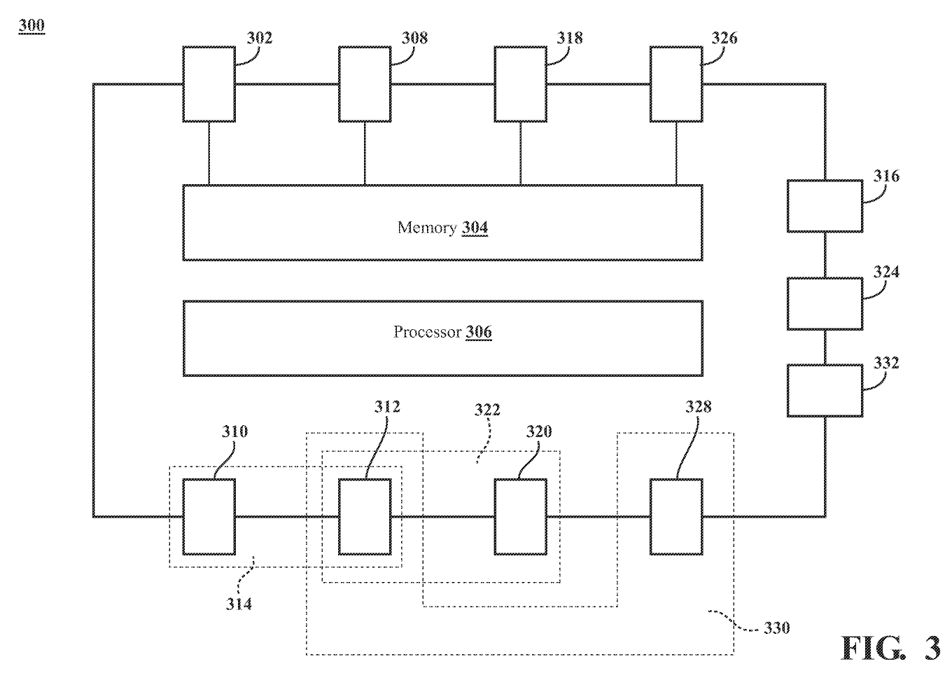

FIG. 2 includes a block diagram that illustrates an example of an environment 200 for verifying a repair of the plasma torch 100, according to the disclosed technologies. The environment 200 can include, for example, the plasma torch 100, an electrical energy source 202, an air supply 204, and a system 206 for verifying the repair of the plasma torch 100. For example, the electrical energy source 202 can be configured to produce or convey an electrical energy with an alternating current. For example, an electrical potential of the electrical energy can be between 100 and 480 volts. For example, a frequency of the alternating current can be in the radio frequency range of the electromagnetic spectrum. (e.g., kilohertz to megahertz). With reference to FIGS. 1A, 1B, and 2, additionally, for example, a cable 208 can be configured to convey the electrical energy from the electrical energy source 202 to the electrical connector 106. For example, the air supply 204 can be configured to produce or convey air. For example, a pressure of the air can be between 90 and 100 pounds per square inch. Additionally, for example, an air tube 210 can be configured to convey the air from the air supply 204 to the air supply connector 114.

For example, the system 206 can include a tool configured to grip 212, a rotational speed sensor 214, a memory 216, and a processor 218. The rotational speed sensor 214 can be communicably coupled to the memory 216. The memory 216 can be communicably coupled to the processor 218. For example, the tool configured to grip 212 can be configured to hold the plasma torch 100. For example, the rotational speed sensor 214 can be configured to measure a rotational speed of the plasma torch 100. For example, the memory 216 can be configured to store a measurement of the rotational speed. For example, the processor 218 can be configured to: (1) determine a first result and (2) produce a signal indicative of the first result. For example, the first result can be of a comparison between the measurement of the rotational speed and a desired range of measurements of the rotational speed.

Additionally, for example, the system 206 can further include a pressure sensor 220. The pressure sensor 220 can be communicably coupled to the memory 216. For example, the pressure sensor 220 can be configured to measure a pressure of air feedback from the plasma torch 100. For example, the memory 216 can be further configured to store a measurement of the pressure. For example, the processor 218 can be further configured to: (1) determine a second result and (2) produce a signal indicative of the second result. For example, the second result can be of a comparison between the measurement of the pressure and a desired range of measurements of the pressure.

For example: (1) a first set of operations can include measuring the pressure, storing the measurement of the pressure, determining the second result, and producing the signal indicative of the second result and (2) a second set of operations can include measuring the rotational speed, storing the measurement of the rotational speed, determining the first result, and producing the signal indicative of the first result. For example, the system 206 can be configured so that: (1) a performance of the first set of operations occurs during a first duration of time and (2) a performance of the second set of operations occurs during a second duration of time. For example, the second duration of time can be after the first duration of time.

Additionally, for example, the system 206 can include a user interface 222. For example, the user interface 222 can include a control element 224 and a control element 226. For example, the control element 224 can be configured to cause, in response to an activation of the control element 224, an initiation of the performance of the first set of operations. For example, the control element 226 can be configured to cause, in response to an activation of the control element 226, an initiation of the performance of the second set of operations. Alternatively, for example, the user interface 222 can include a control element 228. For example, the control element 228 can be configured to cause, in response to an activation of the control element 228, an initiation of both the performance of the first set of operations and the performance of the second set of operations. For example, one or more of the control element 224, the control element 226, or the control element 228 can include a button.

Alternatively, for example, the performance of the second set of operations can include a performance, in response to an existence of a condition, of the second set of operations. For example, the condition can be the measurement of the pressure being within the desired range of measurements of the pressure. For example, the control element 224 can be configured to cause, in response to an activation of the control element 224, an initiation of the performance of the first set of operations. For example, the control element 226 can be configured to cause, in response to an activation of the control element 226, an initiation of the performance of the second set of operations. For example, the control element 226 can be configured to be enabled, in response to the existence of the condition, to be activated. That is, the control element 226 can be configured to be inoperable until the control element 226 is enabled. Alternatively, for example, the control element 228 can be configured to cause, in response to an activation of the control element 228, an initiation of one or more of the performance of the first set of operations or the performance of the second set of operations. That is, the control element 228 can be configured to initiate the performance of the first set of operations and thereafter, in response to the existence of the condition, initiate the performance of the second set of operations.

Additionally, for example, the system 206 can further include a voltage and amperage sensor 230. The voltage and amperage sensor 230 can be communicably coupled to the memory 216. For example, the voltage and amperage sensor 230 can be configured to measure a voltage and an amperage applied to the plasma torch 100. For example, the memory 216 can be further configured to store measurements of the voltage and the amperage. For example, the processor 218 can be further configured to: (1) determine a third result and (2) produce a signal indicative of the third result. For example, the third result can be of a comparison between the measurement of the voltage and a desired range of measurements of the voltage.

For example: (1) a first set of operations can include measuring the rotational speed, storing the measurement of the rotational speed, determining the first result, and producing the signal indicative of the first result and (2) a second set of operations can include measuring the voltage, storing the measurement of the voltage, determining the third result, and producing the signal indicative of the third result. For example, the system 206 can be configured so that: (1) a performance of the first set of operations occurs during a first duration of time and (2) a performance of the second set of operations occurs during a second duration of time. For example, the second duration of time can be after the first duration of time.

Additionally, for example, the system 206 can include the user interface 222. For example, the user interface 222 can include the control element 226 and a control element 232. For example, the control element 226 can be configured to cause, in response to an activation of the control element 226, an initiation of the performance of the first set of operations. For example, the control element 232 can be configured to cause, in response to an activation of the control element 232, an initiation of the performance of the second set of operations. Alternatively, for example, the user interface 222 can include a control element 234. For example, the control element 234 can be configured to cause, in response to an activation of the control element 234, an initiation of both the performance of the first set of operations and the performance of the second set of operations. For example, one or more of the control element 226, the control element 232, or the control element 234 can include a button.

Alternatively, for example, the performance of the second set of operations can include a performance, in response to an existence of a condition, of the second set of operations. For example, the condition can be the measurement of the rotational speed being within the desired range of measurements of the rotational speed. For example, the control element 226 can be configured to cause, in response to an activation of the control element 226, an initiation of the performance of the first set of operations. For example, the control element 232 can be configured to cause, in response to an activation of the control element 232, an initiation of the performance of the second set of operations. For example, the control element 232 can be configured to be enabled, in response to the existence of the condition, to be activated. That is, the control element 232 can be configured to be inoperable until the control element 232 is enabled. Alternatively, for example, the control element 234 can be configured to cause, in response to an activation of the control element 234, an initiation of one or more of the performance of the first set of operations or the performance of the second set of operations. That is, the control element 234 can be configured to initiate the performance of the first set of operations and thereafter, in response to the existence of the condition, initiate the performance of the second set of operations.

Additionally, for example, the system 206 can further include a photodetector 236. The photodetector 236 can be communicably coupled to the memory 216. For example, the photodetector 236 can be configured to measure an intensity of a light conveyed through the optic cable 124 of the flame detection system 122 of the plasma torch 100. For example, the memory 216 can be further configured to store a measurement of the intensity. For example, the processor 218 can be further configured to: (1) determine a fourth result and (2) produce a signal indicative of the fourth result. For example, the fourth result can be of a comparison between the measurement of the intensity and a desired range of measurements of the intensity.

For example, the photodetector 236 can be configured to measure the intensity of the light conveyed through the optic cable 124 by measuring, using a loopback technique, the intensity of the light conveyed through the optic cable 124. For example, the photodetector 236 can be a component of a loopback adapter 238. For example, the loopback adapter 238 can also include a light source 240. For example, the light source 240 can be a light-emitting diode. Alternatively, the loopback adapter 238 can exclude the light source 240 and the light used for the loopback technique can be a plasma flame. For example, the loopback adapter 238 can also include an optic cable 242. For example, the loopback adapter 238 can be configured to be connected to each end of the optic cable 124 to form a closed loop. For example, light produced by the light source 240 (or the plasma flame) can be conveyed through the optic cable 124 and the intensity of the light can be measured by the photodetector 236. For example, the photodetector 236 can be configured to convert the intensity of the light into an electrical signal. For example, the electrical signal can be characterized by an electrical potential difference and a current. For example, the measurement of the intensity can include a measurement of the electrical potential difference and a measurement of the current. For example, the desired range of measurements of the intensity can include a desired range of measurements of the electrical potential difference and a desired range of measurements of the current.

For example: (1) a first set of operations can include measuring the rotational speed, storing the measurement of the rotational speed, determining the first result, and producing the signal indicative of the first result and (2) a second set of operations can include measuring the intensity, storing the measurement of the intensity, determining the fourth result, and producing the signal indicative of the fourth result. For example, the system 206 can be configured so that: (1) a performance of the first set of operations occurs during a first duration of time and (2) a performance of the second set of operations occurs during a second duration of time. For example, the second duration of time can be after the first duration of time.

Additionally, for example, the system 206 can include the user interface 222. For example, the user interface 222 can include the control element 226 and a control element 244. For example, the control element 226 can be configured to cause, in response to an activation of the control element 226, an initiation of the performance of the first set of operations. For example, the control element 244 can be configured to cause, in response to an activation of the control element 244, an initiation of the performance of the second set of operations. Alternatively, for example, the user interface 222 can include a control element 246. For example, the control element 246 can be configured to cause, in response to an activation of the control element 246, an initiation of both the performance of the first set of operations and the performance of the second set of operations. For example, one or more of the control element 226, the control element 244, or the control element 246 can include a button.

Alternatively, for example, the performance of the second set of operations can include a performance, in response to an existence of a condition, of the second set of operations. For example, the condition can be the measurement of the rotational speed being within the desired range of measurements of the rotational speed. For example, the control element 226 can be configured to cause, in response to an activation of the control element 226, an initiation of the performance of the first set of operations. For example, the control element 244 can be configured to cause, in response to an activation of the control element 244, an initiation of the performance of the second set of operations. For example, the control element 244 can be configured to be enabled, in response to the existence of the condition, to be activated. That is, the control element 244 can be configured to be inoperable until the control element 244 is enabled. Alternatively, for example, the control element 246 can be configured to cause, in response to an activation of the control element 246, an initiation of one or more of the performance of the first set of operations or the performance of the second set of operations. That is, the control element 246 can be configured to initiate the performance of the first set of operations and thereafter, in response to the existence of the condition, initiate the performance of the second set of operations.

Alternatively, for example: (1) a first set of operations can include measuring the rotational speed, storing the measurement of the rotational speed, determining the first result, and producing the signal indicative of the first result, (2) a second set of operations can include measuring the voltage and the amperage, storing the measurement of the voltage and the amperage, determining the third result, and producing the signal indicative of the third result, and (3) a third set of operations can include measuring the intensity, storing the measurement of the intensity, determining the fourth result, and producing the signal indicative of the fourth result. For example, the system 206 can be configured so that: (1) a performance of the first set of operations occurs during a first duration of time, (2) a performance of the second set of operations occurs during a second duration of time, and (3) a performance of the third set of operations occurs during a third duration of time. For example, the second duration of time can be after the first duration of time. For example, the third duration of time can be after the second duration of time.

Alternatively, for example, the performance of the second set of operations can include a performance, in response to an existence of a first condition, of the second set of operations. For example, the first condition can be the measurement of the rotational speed being within the desired range of measurements of the rotational speed. For example, the performance of the third set of operations can include a performance, in response to an existence of a second condition, of the third set of operations. For example, the second condition can be the measurement of the voltage being within the desired range of measurements of the voltage.

Alternatively, for example: (1) a first set of operations can include measuring the pressure, storing the measurement of the pressure, determining the second result, and producing the signal indicative of the second result, (2) a second set of operations can include measuring the rotational speed, storing the measurement of the rotational speed, determining the first result, and producing the signal indicative of the first result, (3) a third set of operations can include measuring the voltage and the amperage, storing the measurements of the voltage and the amperage, determining the third result, and producing the signal indicative of the third result, and (4) a fourth set of operations can include measuring the intensity, storing the measurement of the intensity, determining the fourth result, and producing the signal indicative of the fourth result. For example, the system 206 can be configured so that: (1) a performance of the first set of operations occurs during a first duration of time, (2) a performance of the second set of operations occurs during a second duration of time, (3) a performance of the third set of operations occurs during a third duration of time, and (4) a performance of the fourth set of operations occurs during a fourth duration of time. For example, the second duration of time can be after the first duration of time. For example, the third duration of time can be after the second duration of time. For example, the fourth duration of time can be after the third duration of time.

Alternatively, for example, the performance of the second set of operations can include a performance, in response to an existence of a first condition, of the second set of operations. For example, the first condition can be the measurement of the pressure being within the desired range of measurements of the pressure. For example, the performance of the third set of operations can include a performance, in response to an existence of a second condition, of the third set of operations. For example, the second condition can be the measurement of the rotational speed being within the desired range of measurements of the rotational speed. For example, the performance of the fourth set of operations can include a performance, in response to an existence of a third condition, of the fourth set of operations. For example, the third condition can be the measurement of the voltage being within the desired range of measurements of the voltage.

For example, within the environment 200, a portion of the system 206 can be located within a designated space 248. Additionally, for example, the system 206 can include a mechanism 250 configured to detect if another object (e.g., a portion of a human being) has entered into the designated space 248. For example, the mechanism 250 can use infrared light beams to detect if the other object has entered into the designated space 248. For example, the mechanism 250 can be further configured to cause, in response to a detection of the other object within the designated space 248, a cessation of operations associated with verifying the repair of the plasma torch 100. For example, the mechanism 250 can include a light curtain.

FIG. 3 includes a block diagram that illustrates an example of a controller 300 for verifying a repair of a plasma torch, according to the disclosed technologies. For example, the controller 300 can include a port 302, a memory 304, and a processor 306. The port 302 can be communicably coupled to the memory 304. The memory 304 can be communicably coupled to the processor 306. For example, the port 302 can be configured to receive, from a rotational speed sensor, a measurement of a rotational speed of the plasma torch. For example, the memory 304 can be configured to store the measurement of the rotational speed. For example, the processor 306 can be configured to: (1) determine a first result and (2) produce a signal indicative of the first result. For example, the first result can be of a comparison between the measurement of the rotational speed and a desired range of measurements of the rotational speed.

Additionally, for example, the controller 300 can further include a port 308. The port 308 can be communicably coupled to the memory 304. For example, the port 308 can be configured to receive, from a pressure sensor, a measurement of a pressure of air feedback from the plasma torch. For example, the memory 304 can be further configured to store the measurement of the pressure. For example, the processor 306 can be configured to: (1) determine a second result and (2) produce a signal indicative of the second result. For example, the second result can be of a comparison between the measurement of the pressure and a desired range of measurements of the pressure.

For example: (1) a first set of operations can include measuring the pressure, storing the measurement of the pressure, determining the second result, and producing the signal indicative of the second result and (2) a second set of operations can include measuring the rotational speed, storing the measurement of the rotational speed, determining the first result, and producing the signal indicative of the first result. For example, the controller 300 can be configured so that: (1) a performance of the first set of operations occurs during a first duration of time and (2) a performance of the second set of operations occurs during a second duration of time. For example, the second duration of time can be after the first duration of time.

Additionally, for example, the controller 300 can include a port 310 and a port 312. For example, the port 310 can be configured to receive, from a first control element on a user interface, a first signal configured to cause an initiation of the performance of the first set of operations. For example, the port 312 can be configured to receive, from a second control element on the user interface, a second signal configured to cause an initiation of the performance of the second set of operations. Alternatively, for example, the controller 300 can include a port 314. For example, the port 314 can be configured to receive, from a control element on the user interface, a signal configured to cause an initiation of both the performance of the first set of operations and the performance of the second set of operations.

Alternatively, for example, the performance of the second set of operations can include a performance, in response to an existence of a condition, of the second set of operations. For example, the condition can be the measurement of the pressure being within the desired range of measurements of the pressure. Additionally, for example, the controller 300 can include a port 316. For example, the port 310 can be configured to receive, from a first control element on a user interface, a first signal configured to cause an initiation of the performance of the first set of operations. For example, the port 316 can be configured to transmit, to a second control element on the user interface, a second signal indicative of a status of the existence of the condition. That is, the second control element can be configured to be inoperable until the second control element is enabled. For example, the port 312 can be configured to receive, from the second control element, a third signal configured to cause an initiation of the performance of the second set of operations. Alternatively, for example, the port 314 can be configured to receive, from a control element on the user interface, a signal configured to cause an initiation of one or more of the performance of the first set of operations or the performance of the second set of operations. That is, the control element can be configured to initiate the performance of the first set of operations and thereafter, in response to the existence of the condition, initiate the performance of the second set of operations.

Additionally, for example, the controller 300 can further include a port 318. The port 318 can be communicably coupled to the memory 304. For example, the port 318 can be configured to receive, from a voltage sensor, measurements of a voltage and an amperage applied to the plasma torch. For example, the memory 304 can be further configured to store the measurements of the voltage and the amperage. For example, the processor 306 can be configured to: (1) determine a third result and (2) produce a signal indicative of the third result. For example, the third result can be of a comparison between the measurement of the voltage and a desired range of measurements of the voltage.

For example: (1) a first set of operations can include measuring the rotational speed, storing the measurement of the rotational speed, determining the first result, and producing the signal indicative of the first result and (2) a second set of operations can include measuring the voltage, storing the measurement of the voltage, determining the third result, and producing the signal indicative of the third result. For example, the controller 300 can be configured so that: (1) a performance of the first set of operations occurs during a first duration of time and (2) a performance of the second set of operations occurs during a second duration of time. For example, the second duration of time can be after the first duration of time.

Additionally, for example, the controller 300 can include the port 312 and a port 320. For example, the port 312 can be configured to receive, from a first control element on the user interface, a first signal configured to cause an initiation of the performance of the first set of operations. For example, the port 320 can be configured to receive, from a second control element on the user interface, a second signal configured to cause an initiation of the performance of the second set of operations. Alternatively, for example, the controller 300 can include a port 322. For example, the port 322 can be configured to receive, from a control element on the user interface, a signal configured to cause an initiation of both the performance of the first set of operations and the performance of the second set of operations.

Alternatively, for example, the performance of the second set of operations can include a performance, in response to an existence of a condition, of the second set of operations. For example, the condition can be the measurement of the rotational speed being within the desired range of measurements of the rotational speed. Additionally, for example, the controller 300 can include a port 324. For example, the port 312 can be configured to receive, from a first control element on a user interface, a first signal configured to cause an initiation of the performance of the first set of operations. For example, the port 324 can be configured to transmit, to a second control element on the user interface, a second signal indicative of a status of the existence of the condition. That is, the second control element can be configured to be inoperable until the second control element is enabled. For example, the port 320 can be configured to receive, from the second control element, a third signal configured to cause an initiation of the performance of the second set of operations. Alternatively, for example, the port 322 can be configured to receive, from a control element on the user interface, a signal configured to cause an initiation of one or more of the performance of the first set of operations or the performance of the second set of operations. That is, the control element can be configured to initiate the performance of the first set of operations and thereafter, in response to the existence of the condition, initiate the performance of the second set of operations.

Additionally, for example, the controller 300 can further include a port 326. The port 328 can be communicably coupled to the memory 304. For example, the port 326 can be configured to receive, from a photodetector, a measurement of an intensity of a light conveyed through an optic cable of a flame detection system of the plasma torch. For example, the memory 304 can be further configured to store the measurement of the intensity. For example, the processor 306 can be configured to: (1) determine a fourth result and (2) produce a signal indicative of the fourth result. For example, the fourth result can be of a comparison between the measurement of the intensity and a desired range of measurements of the intensity.

For example: (1) a first set of operations can include measuring the rotational speed, storing the measurement of the rotational speed, determining the first result, and producing the signal indicative of the first result and (2) a second set of operations can include measuring the intensity, soring the measurement of the intensity, determining the fourth result, and producing the signal indicative of the fourth result. For example, the controller 300 can be configured so that: (1) a performance of the first set of operations occurs during a first duration of time and (2) a performance of the second set of operations occurs during a second duration of time. For example, the second duration of time can be after the first duration of time.

Alternatively, for example, the performance of the second set of operations can include a performance, in response to an existence of a condition, of the second set of operations. For example, the condition can be the measurement of the rotational speed being within the desired range of measurements of the rotational speed. Additionally, for example, the controller 300 can include a port 332. For example, the port 312 can be configured to receive, from a first control element on a user interface, a first signal configured to cause an initiation of the performance of the first set of operations. For example, the port 332 can be configured to transmit, to a second control element on the user interface, a second signal indicative of a status of the existence of the condition. That is, the second control element can be configured to be inoperable until the second control element is enabled. For example, the port 328 can be configured to receive, from the second control element, a third signal configured to cause an initiation of the performance of the second set of operations. Alternatively, for example, the port 330 can be configured to receive, from a control element on the user interface, a signal configured to cause an initiation of one or more of the performance of the first set of operations or the performance of the second set of operations. That is, the control element can be configured to initiate the performance of the first set of operations and thereafter, in response to the existence of the condition, initiate the performance of the second set of operations.

Alternatively, for example, the performance of the second set of operations can include a performance, in response to an existence of a condition, of the second set of operations. For example, the condition can be the measurement of the rotational speed being within the desired range of measurements of the rotational speed. Additionally, for example, the controller 300 can include a port 332. For example, the port 312 can be configured to receive, from a first control element on a user interface, a first signal configured to cause an initiation of the performance of the first set of operations. For example, the port 332 can be configured to transmit, to a second control element on the user interface, a second signal indicative of a status of the existence of the condition. That is, the second control element can be configured to be inoperable until the second control element is enabled. For example, the port 328 can be configured to receive, from the second control element, a third signal configured to cause an initiation of the performance of the second set of operations. Alternatively, for example, the port 330 can be configured to receive, from a control element on the user interface, a signal configured to cause an initiation of one or more of the performance of the first set of operations or the performance of the second set of operations. That is, the control element can be configured to initiate the performance of the first set of operations and thereafter, in response to the existence of the condition, initiate the performance of the second set of operations.

Alternatively, for example: (1) a first set of operations can include measuring the rotational speed, storing the measurement of the rotational speed, determining the first result, and producing the signal indicative of the first result, (2) a second set of operations can include measuring the voltage and the amperage, storing the measurements of the voltage and the amperage, determining the third result, and producing the signal indicative of the third result, and (3) a third set of operations can include measuring the intensity, storing the measurement of the intensity, determining the fourth result, and producing the signal indicative of the fourth result. For example, the system 206 can be configured so that: (1) a performance of the first set of operations occurs during a first duration of time, (2) a performance of the second set of operations occurs during a second duration of time, and (3) a performance of the third set of operations occurs during a third duration of time. For example, the second duration of time can be after the first duration of time. For example, the third duration of time can be after the second duration of time.

Alternatively, for example, the performance of the second set of operations can include a performance, in response to an existence of a first condition, of the second set of operations. For example, the first condition can be the measurement of the rotational speed being within the desired range of measurements of the rotational speed. For example, the performance of the third set of operations can include a performance, in response to an existence of a second condition, of the third set of operations. For example, the second condition can be the measurement of the voltage being within the desired range of measurements of the voltage.

Alternatively, for example: (1) a first set of operations can include measuring the pressure, storing the measurement of the pressure, determining the second result, and producing the signal indicative of the second result, (2) a second set of operations can include measuring the rotational speed, storing the measurement of the rotational speed, determining the first result, and producing the signal indicative of the first result, (3) a third set of operations can include measuring the voltage and the amperage, storing the measurements of the voltage and the amperage, determining the third result, and producing the signal indicative of the third result, and (4) a fourth set of operations can include measuring the intensity, storing the measurement of the intensity, determining the fourth result, and producing the signal indicative of the fourth result. For example, the system 206 can be configured so that: (1) a performance of the first set of operations occurs during a first duration of time, (2) a performance of the second set of operations occurs during a second duration of time, (3) a performance of the third set of operations occurs during a third duration of time, and (4) a performance of the fourth set of operations occurs during a fourth duration of time. For example, the second duration of time can be after the first duration of time. For example, the third duration of time can be after the second duration of time. For example, the fourth duration of time can be after the third duration of time.

Alternatively, for example, the performance of the second set of operations can include a performance, in response to an existence of a first condition, of the second set of operations. For example, the first condition can be the measurement of the pressure being within the desired range of measurements of the pressure. For example, the performance of the third set of operations can include a performance, in response to an existence of a second condition, of the third set of operations. For example, the second condition can be the measurement of the rotational speed being within the desired range of measurements of the rotational speed. For example, the performance of the fourth set of operations can include a performance, in response to an existence of a third condition, of the fourth set of operations. For example, the third condition can be the measurement of the voltage being within the desired range of measurements of the voltage.

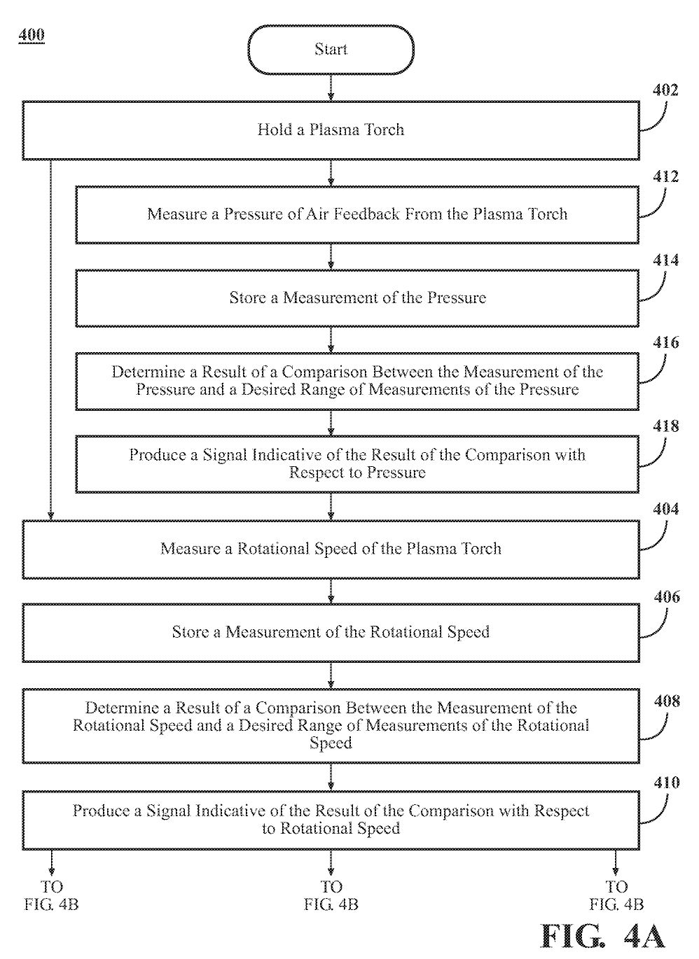

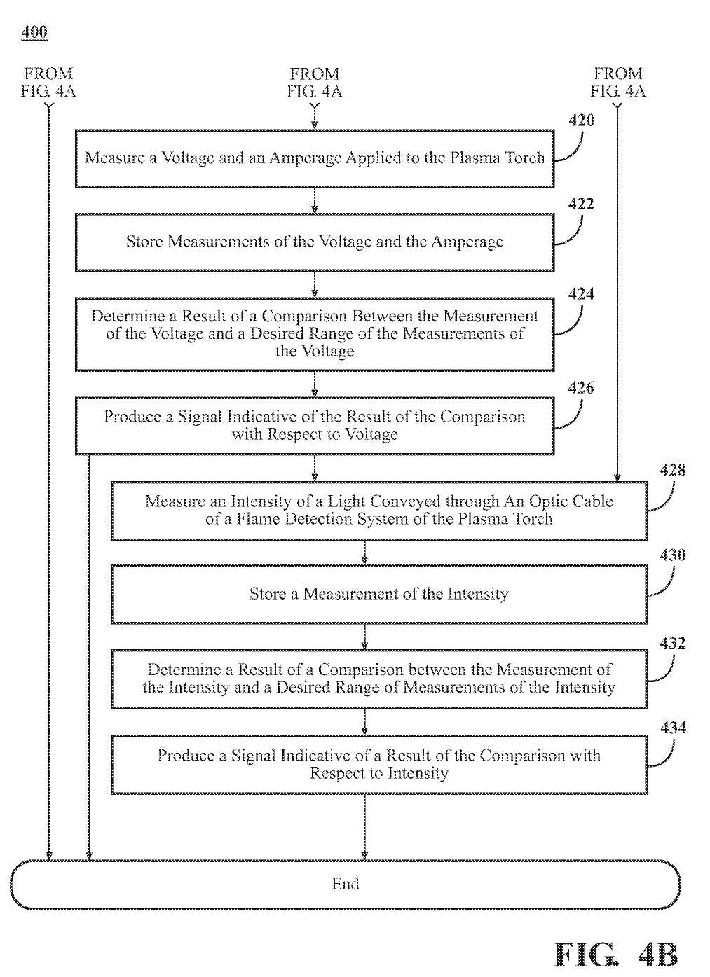

FIGS. 4A and 4B include a flow diagram that illustrates an example of a method 400 that is associated with verifying a repair of a plasma torch, according to the disclosed technologies. Although the method 400 is described in combination with the system 206 illustrated in FIG. 2, one of skill in the art understands, in light of the description herein, that the method 400 is not limited to being implemented by the system 206 illustrated in FIG. 2. Rather, the system 206 illustrated in FIG. 2 is an example of a system that may be used to implement the method 400. Additionally, although the method 400 is illustrated as a generally serial process, various aspects of the method 400 may be able to be executed in parallel. For example, the plasma torch can include a handheld plasma torch. For example, the plasma torch can include a plasma surface treatment tool. For example, the plasma surface treatment tool can be an atmospheric plasma surface treatment tool. For example, the plasma surface treatment tool can be a rotating plasma surface treatment tool.

In FIG. 4A, in the method 400, at an operation 402, for example, the tool configured to grip 212 can hold the plasma torch.

At an operation 404, for example, the rotational speed sensor 214 can measure a rotational speed of the plasma torch.

At an operation 406, for example, the memory 216 can store a measurement of the rotational speed.

At an operation 408, for example, the processor 218 can determine a first result. For example, the first result can be of a comparison between the measurement of the rotational speed and a desired range of measurements of the rotational speed.

At an operation 410, for example, the processor 218 can produce a signal indicative of the first result.

Additionally, at an operation 412, for example, the pressure sensor 220 can measure a pressure of air feedback from the plasma torch.

Additionally, at an operation 414, for example, the memory 216 can store a measurement of the pressure.

Additionally, at an operation 416 for example, the processor 218 can determine a second result. For example, the second result can be of a comparison between the measurement of the pressure and a desired range of measurements of the pressure.

Additionally, at an operation 418, for example, the processor 218 can produce a signal indicative of the second result.

For example: (1) a first set of operations can include the operation 412, the operation 414, the operation 416, and the operation 418 and (2) a second set of operations can include the operation 404, the operation 406, the operation 408, and the operation 410. For example: (1) a performance of the first set of operations can occur during a first duration of time and (2) a performance of the second set of operations can occur during a second duration of time. For example, the second duration of time can be after the first duration of time.

For example, an initiation of a performance of the first set of operations can occur in response to an activation of the control element 224 on the user interface 222. For example, an initiation of a performance of the second set of operations can occur in response to an activation of the control element 226 on the user interface 222. Alternatively, for example, an initiation of both the performance of the first set of operations and the performance of the second set of operations can occur in response to an activation of the control element 228 on the user interface 222.

Alternatively, for example, the performance of the second set of operations can include a performance, in response to an existence of a condition, of the second set of operations. For example, the condition can be the measurement of the pressure being within the desired range of measurements of the pressure. For example, an initiation of a performance of the first set of operations can occur in response to an activation of the control element 224 on the user interface 222. For example, an initiation of a performance of the second set of operations can occur in response to an activation of the control element 226 on the user interface 222. For example, the control element 226 can be configured to be enabled, in response to the existence of the condition, to be activated. That is, the control element 226 can be configured to be inoperable until the control element 226 is enabled. Alternatively, for example, an initiation of one or more of the performance of the first set of operations or the performance of the second set of operations can occur in response to an activation of the control element 228 on the user interface 222. That is, the control element 228 can be configured to initiate the performance of the first set of operations and thereafter, in response to the existence of the condition, initiate the performance of the second set of operations.

In FIG. 4B, in the method 400, additionally, at an operation 420, for example, the voltage sensor 230 can measure a voltage and an amperage applied to the plasma torch.

Additionally, at an operation 422, for example, the memory 216 can store measurements of the voltage and the amperage.

Additionally, at an operation 424, for example, the processor 218 can determine a third result. For example, the third result can be of a comparison between the measurement of the voltage and a desired range of measurements of the voltage.

Additionally, at an operation 426, for example, the processor 218 can produce a signal indicative of the third result.

For example: (1) a first set of operations can include the operation 404, the operation 406, the operation 408, and the operation 410 and (2) a second set of operations can include the operation 422, the operation 422, the operation 424, and the operation 426. For example: (1) a performance of the first set of operations can occur during a first duration of time and (2) a performance of the second set of operations can occur during a second duration of time. For example, the second duration of time can be after the first duration of time.

For example, an initiation of a performance of the first set of operations can occur in response to an activation of the control element 226 on the user interface 222. For example, an initiation of a performance of the second set of operations can occur in response to an activation of the control element 232 on the user interface 222. Alternatively, for example, an initiation of both the performance of the first set of operations and the performance of the second set of operations can occur in response to an activation of the control element 234 on the user interface 222.

Alternatively, for example, the performance of the second set of operations can include a performance, in response to an existence of a condition, of the second set of operations. For example, the condition can be the measurement of the pressure being within the desired range of measurements of the pressure. For example, an initiation of a performance of the first set of operations can occur in response to an activation of the control element 226 on the user interface 222. For example, an initiation of a performance of the second set of operations can occur in response to an activation of the control element 232 on the user interface 222. For example, the control element 232 can be configured to be enabled, in response to the existence of the condition, to be activated. That is, the control element 232 can be configured to be inoperable until the control element 232 is enabled. Alternatively, for example, an initiation of one or more of the performance of the first set of operations or the performance of the second set of operations can occur in response to an activation of the control element 234 on the user interface 222. That is, the control element 234 can be configured to initiate the performance of the first set of operations and thereafter, in response to the existence of the condition, initiate the performance of the second set of operations.

Additionally, at an operation 428, for example, the photodetector 236 can measure an intensity of a light conveyed through an optic cable of a flame detection system of the plasma torch.

Additionally, at an operation 430, for example, the memory 216 can store a measurement of the intensity.

Additionally, at an operation 432, for example, the processor 218 can determine a fourth result. For example, the fourth result can be of a comparison between the measurement of the intensity and a desired range of measurements of the intensity.

Additionally, at an operation 434, for example, the processor 218 can produce a signal indicative of the fourth result.

For example, the photodetector 236 can be configured to measure the intensity of the light conveyed through the optic cable by measuring, using a loopback technique, the intensity of the light conveyed through the optic cable. For example, the photodetector 236 can be a component of the loopback adapter 238. For example, the loopback adapter 238 can also include the light source 240. For example, the light source 240 can be a light-emitting diode. Alternatively, the loopback adapter 238 can exclude the light source 240 and the light used for the loopback technique can be a plasma flame. For example, the loopback adapter 238 can also include the optic cable 242. For example, the loopback adapter 238 can be configured to be connected to each end of the optic cable, of the flame detection system of the plasma torch, to form a closed loop. For example, light produced by the light source 240 (or the plasma flame) can be conveyed through the optic cable, of the flame detection system of the plasma torch, and the intensity of the light can be measured by the photodetector 236. For example, the photodetector 236 can be configured to convert the intensity of the light into an electrical signal. For example, the electrical signal can be characterized by an electrical potential difference and a current. For example, the measurement of the intensity can include a measurement of the electrical potential difference and a measurement of the current. For example, the desired range of measurements of the intensity can include a desired range of measurements of the electrical potential difference and a desired range of measurements of the current.

For example: (1) a first set of operations can include the operation 404, the operation 406, the operation 408, and the operation 410 and (2) a second set of operations can include the operation 428, the operation 430, the operation 432, and the operation 434. For example: (1) a performance of the first set of operations can occur during a first duration of time and (2) a performance of the second set of operations can occur during a second duration of time. For example, the second duration of time can be after the first duration of time.

For example, an initiation of a performance of the first set of operations can occur in response to an activation of the control element 226 on the user interface 222. For example, an initiation of a performance of the second set of operations can occur in response to an activation of the control element 244 on the user interface 222. Alternatively, for example, an initiation of both the performance of the first set of operations and the performance of the second set of operations can occur in response to an activation of the control element 246 on the user interface 222.

Alternatively, for example, the performance of the second set of operations can include a performance, in response to an existence of a condition, of the second set of operations. For example, the condition can be the measurement of the pressure being within the desired range of measurements of the pressure. For example, an initiation of a performance of the first set of operations can occur in response to an activation of the control element 226 on the user interface 222. For example, an initiation of a performance of the second set of operations can occur in response to an activation of the control element 244 on the user interface 222. For example, the control element 244 can be configured to be enabled, in response to the existence of the condition, to be activated. That is, the control element 244 can be configured to be inoperable until the control element 244 is enabled. Alternatively, for example, an initiation of one or more of the performance of the first set of operations or the performance of the second set of operations can occur in response to an activation of the control element 246 on the user interface 222. That is, the control element 246 can be configured to initiate the performance of the first set of operations and thereafter, in response to the existence of the condition, initiate the performance of the second set of operations.

Alternatively, for example: (1) a first set of operations can include the operation 404, the operation 406, the operation 408, and the operation 410, (2) a second set of operations can include the operation 420, the operation 422, the operation 424, and the operation 426, and (3) a third set of operations can include the operation 428, the operation 430, the operation 432, and the operation 434. For example: (1) a performance of the first set of operations can occur during a first duration of time, (2) a performance of the second set of operations can occur during a second duration of time, and (3) a performance of the third set of operations can occur during a third duration of time. For example, the second duration of time can be after the first duration of time. For example, the third duration of time can be after the second duration of time.

Alternatively, for example, the performance of the second set of operations can include a performance, in response to an existence of a first condition, of the second set of operations. For example, the first condition can be the measurement of the rotational speed being within the desired range of measurements of the rotational speed. For example, the performance of the third set of operations can include a performance, in response to an existence of a second condition, of the third set of operations. For example, the second condition can be the measurement of the voltage being within the desired range of measurements of the voltage.

Alternatively, for example: (1) a first set of operations can include the operation 412, the operation 414, the operation 416, and the operation 418, (2) a second set of operations can include the operation 404, the operation 406, the operation 408, and the operation 410, (3) a third set of operations can include the operation 420, the operation 422, the operation 424, and the operation 426, and (4) a fourth set of operations can include the operation 428, the operation 430, the operation 432, and the operation 434. For example: (1) a performance of the first set of operations can occur during a first duration of time, (2) a performance of the second set of operations can occur during a second duration of time, and (3) a performance of the third set of operations occurs during a third duration of time, and (4) a performance of the fourth set of operations occurs during a fourth duration of time. For example, the second duration of time can be after the first duration of time. For example, the third duration of time can be after the second duration of time. For example, the fourth duration of time can be after the third duration of time.

example, the performance of the second set of operations can include a performance, in response to an existence of a first condition, of the second set of operations. For example, the first condition can be the measurement of the pressure being within the desired range of measurements of the pressure. For example, the performance of the third set of operations can include a performance, in response to an existence of a second condition, of the third set of operations. For example, the second condition can be the measurement of the rotational speed being within the desired range of measurements of the rotational speed. For example, the performance of the fourth set of operations can include a performance, in response to an existence of a third condition, of the fourth set of operations. For example, the third condition can be the measurement of the voltage being within the desired range of measurements of the voltage.

Detailed embodiments are disclosed herein. However, one of skill in the art understands, in light of the description herein, that the disclosed embodiments are intended only as examples. Therefore, specific structural and functional details disclosed herein are not to be interpreted as limiting, but merely as a basis for the claims and as a representative basis for teaching one of skill in the art to variously employ the aspects herein in virtually any appropriately detailed structure. Furthermore, the terms and phrases used herein are not intended to be limiting but rather to provide an understandable description of possible implementations. Various embodiments are illustrated in FIGS. 1A, 1B, 2, 3, 4A, and 4B, but the embodiments are not limited to the illustrated structure or application.

The flowchart and block diagrams in the figures illustrate the architecture, functionality, and operation of possible implementations of systems, methods, and computer program products according to various embodiments. In this regard, each block in flowcharts or block diagrams may represent a module, segment, or portion of code, which comprises one or more executable instructions for implementing the specified logical function(s). One of skill in the art understands, in light of the description herein, that, in some alternative implementations, the functions described in a block may occur out of the order depicted by the figures. For example, two blocks depicted in succession may, in fact, be executed substantially concurrently, or the blocks may be executed in the reverse order, depending upon the functionality involved.

The systems, components and/or processes described above can be realized in hardware or a combination of hardware and software and can be realized in a centralized fashion in one processing system or in a distributed fashion where different elements are spread across several interconnected processing systems. Any kind of processing system or another apparatus adapted for carrying out the methods described herein is suitable. A typical combination of hardware and software can be a processing system with computer-readable program code that, when loaded and executed, controls the processing system such that it carries out the methods described herein. The systems, components, and/or processes also can be embedded in a computer-readable storage, such as a computer program product or other data programs storage device, readable by a machine, tangibly embodying a program of instructions executable by the machine to perform methods and processes described herein. These elements also can be embedded in an application product that comprises all the features enabling the implementation of the methods described herein and that, when loaded in a processing system, is able to carry out these methods.

Furthermore, arrangements described herein may take the form of a computer program product embodied in one or more computer-readable media having computer-readable program code embodied, e.g., stored, thereon. Any combination of one or more computer-readable media may be utilized. The computer-readable medium may be a computer-readable signal medium or a computer-readable storage medium. As used herein, the phrase “computer-readable storage medium” means a non-transitory storage medium. A computer-readable storage medium may be, for example, but not limited to, an electronic, magnetic, optical, electromagnetic, infrared, or semiconductor system, apparatus, or device, or any suitable combination of the foregoing. More specific examples of the computer-readable storage medium would include, in a non-exhaustive list, the following: a portable computer diskette, a hard disk drive (HDD), a solid-state drive (SSD), a read-only memory (ROM), an erasable programmable read-only memory (EPROM or flash memory), a portable compact disc read-only memory (CD-ROM), a digital versatile disc (DVD), an optical storage device, a magnetic storage device, or any suitable combination of the foregoing. As used herein, a computer-readable storage medium may be any tangible medium that can contain or store a program for use by or in connection with an instruction execution system, apparatus, or device.

Generally, modules, as used herein, include routines, programs, objects, components, data structures, and so on that perform particular tasks or implement particular data types. In further aspects, a memory generally stores such modules. The memory associated with a module may be a buffer or may be cache embedded within a processor, a random-access memory (RAM), a ROM, a flash memory, or another suitable electronic storage medium. In still further aspects, a module as used herein, may be implemented as an application-specific integrated circuit (ASIC), a hardware component of a system on a chip (SoC), a programmable logic array (PLA), or another suitable hardware component (e.g., a central processing unit (CPU), a graphics processing unit (GPU), a field-programmable gate array (FPGA), or the like) that is embedded with a defined configuration set (e.g., instructions) for performing the disclosed functions.

Program code embodied on a computer-readable medium may be transmitted using any appropriate medium, including but not limited to wireless, wireline, optical fiber, cable, radio frequency (RF), etc., or any suitable combination of the foregoing. Computer program code for carrying out operations for aspects of the disclosed technologies may be written in any combination of one or more programming languages, including an object-oriented programming language such as RsLogix5000, FactoryView Studio, or the like, and conventional procedural programming languages such as the “C” programming language or similar programming languages. The program code may execute entirely on a user’s logic controller, partly on a user’s programmable logic controller, as a stand-alone software package, partly on a user’s computer and partly on a remote computer, or entirely on a remote computer or server. In the latter scenario, the remote computer may be connected to the user’s logic controller through any type of network, including a local area network (LAN) or a wide area network (WAN), Universal Serial Bus (USB), or the connection may be made to an external computer (for example, through the Internet using an Internet Service Provider).

The terms “a” and “an,” as used herein, are defined as one or more than one. The term “plurality,” as used herein, is defined as two or more than two. The term “another,” as used herein, is defined as at least a second or more. The terms “including” and/or “having,” as used herein, are defined as comprising (i.e., open language). The phrase “at least one of . . . or . . . ” as used herein refers to and encompasses any and all possible combinations of one or more of the associated listed items. For example, the phrase “at least one of A, B, or C” includes A only, B only, C only, or any combination thereof (e.g., AB, AC, BC, or ABC).

Aspects herein can be embodied in other forms without departing from the spirit or essential attributes thereof. Accordingly, reference should be made to the following claims, rather than to the foregoing specification, as indicating the scope hereof.

What is claimed is:

1. A system, comprising:
a tool configured to grip configured to hold a plasma torch;
a rotational speed sensor configured to measure a rotational speed of the plasma torch;
a memory configured to store a measurement of the rotational speed; and
a processor configured to:
determine a first result, the first result being of a comparison between the measurement of the rotational speed and a desired range of measurements of the rotational speed; and
produce a signal indicative of the first result.

2. The system of claim 1:
further comprising a pressure sensor configured to measure a pressure of air feedback from the plasma torch,
wherein:
the memory is further configured to store a measurement of the pressure; and
the processor is further configured to:
determine a second result, the second result being of a comparison between the measurement of the pressure and a desired range of measurements of the pressure; and
produce a signal indicative of the second result.

3. The system of claim 2, wherein:
a first set of operations comprises measuring the pressure, storing the measurement of the pressure, determining the second result, and producing the signal indicative of the second result,
a second set of operations comprises measuring the rotational speed, storing the measurement of the rotational speed, determining the first result, and producing the signal indicative of the first result,
the system is configured so that:
a performance of the first set of operations occurs during a first duration of time, and
a performance of the second set of operations occurs during a second duration of time, and
the second duration of time is after the first duration of time.

4. The system of claim 3, further comprising a control element, on a user interface, configured to cause, in response to an activation of the control element, an initiation of both the performance of the first set of operations and the performance of the second set of operations.

5. The system of claim 3, wherein:
the performance of the second set of operations comprises a performance, in response to an existence of a condition, of the second set of operations, and
the condition is the measurement of the pressure being within the desired range of measurements of the pressure.

6. The system of claim 5, further comprising a control element, on a user interface, configured to cause, in response to an activation of the control element, an initiation of at least one of the performance of the first set of operations or the performance of the second set of operations.

7. The system of claim 1:
further comprising a voltage and amperage sensor configured to measure a voltage and an amperage applied to the plasma torch,
wherein:
the memory is further configured to store measurements of the voltage and the amperage; and
the processor is further configured to:
determine a second result, the second result being of a comparison between the measurement of the voltage and a desired range of measurements of the voltage; and
produce a signal indicative of the second result.

8. The system of claim 7, wherein:
a first set of operations comprises measuring the rotational speed, storing the measurement of the rotational speed, determining the first result, and producing the signal indicative of the first result,
a second set of operations comprises measuring the voltage and the amperage, storing the measurements of the voltage and the amperage, determining the second result, and producing the signal indicative of the second result,
the system is configured to that:
a performance of the first set of operations occurs during a first duration of time, and
a performance of the second set of operations occurs during a second duration of time, and
the second duration of time is after the first duration of time.

9. The system of claim 8, further comprising a control element, on a user interface, configured to cause, in response to an activation of the control element, an initiation of both the performance of the first set of operations and the performance of the second set of operations.

10. The system of claim 8, wherein:
the performance of the second set of operations comprises a performance, in response to an existence of a condition, of the second set of operations, and
the condition is the measurement of the rotational speed being within the desired range of measurements of the rotational speed.

11. The system of claim 8, further comprising a control element, on a user interface, configured to cause, in response to an activation of the control element, an initiation of at least one of the performance of the first set of operations or the performance of the second set of operations.

12. The system of claim 1:
further comprising a photodetector configured to measure an intensity of a light conveyed through an optic cable of a flame detection system of the plasma torch;
wherein:
the memory is further configured to store a measurement of the intensity; and
the processor is further configured to:
determine a second result, the second result being of a comparison between the measurement of the intensity and a desired range of measurements of the intensity; and
produce a signal indicative of the second result.

13. The system of claim 12, wherein:
a first set of operations comprises measuring the rotational speed, storing the measurement of the rotational speed, determining the first result, and producing the signal indicative of the first result,
a second set of operations comprises measuring the intensity, storing the measurement of the intensity, determining the second result, and producing the signal indicative of the second result,
the system is configured so that:
a performance of the first set of operations occurs during a first duration of time, and
a performance of the second set of operations occurs during a second duration of time, and
the second duration of time is after the first duration of time.

14. The system of claim 13, further comprising a control element, on a user interface, configured to cause, in response to an activation of the control element, an initiation of both the performance of the first set of operations and the performance of the second set of operations.

15. The system of claim 13, wherein:
the performance of the second set of operations comprises a performance, in response to an existence of a condition, of the second set of operations, and
the condition is the measurement of the rotational speed being within the desired range of measurements of the rotational speed.

16. The system of claim 15, further comprising a control element, on a user interface, configured to cause, in response to an activation of the control element, an initiation of at least one of the performance of the first set of operations or the performance of the second set of operations.

17. The system of claim 12:
further comprising a voltage and amperage sensor configured to measure a voltage and an amperage applied to the plasma torch,
wherein:
the memory is further configured to store measurements of the voltage and the amperage; and
the processor is further configured to:
determine a third result, the third result being of a comparison between the measurement of the voltage and a desired range of measurements of the voltage; and
produce a signal indicative of the third result.

18. The system of claim 17:
further comprising a pressure sensor configured to measure a pressure of air feedback from the plasma torch,
wherein:
the memory is further configured to store a measurement of the pressure; and
the processor is further configured to:
determine a fourth result, the fourth result being of a comparison between the measurement of the pressure and a desired range of measurements of the pressure; and
produce a signal indicative of the fourth result.

19. A controller, comprising:
a port configured to receive, from a rotational speed sensor, a measurement of a rotational speed of a plasma torch;
a memory configured to store the measurement of the rotational speed; and
a processor configured to:
determine a result, the result being of a comparison between the measurement of the rotational speed and a desired range of measurements of the rotational speed; and
produce a signal indicative of the result.

20. A method, comprising:
holding, by a tool configured to grip, a plasma torch;
measuring, by a rotational speed sensor, a rotational speed of the plasma torch;
storing, in a memory, a measurement of the rotational speed;
determining, by a processor, a result, the result being of a comparison between the measurement of the rotational speed and a desired range of measurements of the rotational speed; and
producing, by the processor, a signal indicative of the result.
